(19) United States
(12) Patent Application Publication
(10) Pub. No.: US 2008/0141073 A1
(43) Pub. Date: Jun. 12, 2008

(54) BIOS debugging system and method

(75) Inventors: Wen-Hsin Shih, Taipei (TW); Huan-Chih Yu, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/635,823

(22) Filed: Dec. 7, 2006

(51) Int. Cl. G06F 11/00

(52) U.S. Cl. 714/36; 714/E11.001

(57) ABSTRACT

A basic input/output system (BIOS) debugging system and method, which is applicable to a BIOS that has a debugging mechanism hidden by the BIOS in normal operation. The debugging method includes the following steps of (1) determining in a power on self test executed by the BIOS whether at least a preset input mode that is used for a user to enter the debugging mechanism is actuated or not, and proceeding to step (2) if the input mode is actuated, or continuing executing the POST; (2) entering the setting mode of the BIOS and displaying the hidden debugging mechanism; and (3) executing debugging functions provided by the debugging mechanism and/or resetting parameters provided by the debugging mechanism. Accordingly, the present invention allows the user to execute the hidden debugging mechanism after the completion of the BIOS initial setting, thereby, increasing the debugging efficiency.

### BACKGROUND OF THE INVENTION

1. Field of the Invention

This invention relates generally to basic input/output system (BIOS) debugging techniques, and more specifically, to a BIOS debugging system and method, which is applicable to a BIOS that has a debugging mechanism.

2. Description of Related Art

The prior art basic input/output system (BIOS) of a data processing device, such as a personal computer, a notebook computer, or a server, provides a setting mode. Therefore, a user, after entering the setting mode, is allowed to set and execute function-related parameters and switches of the data processing device with various setting functions provided by the BIOS, so as to change configurations of specific modules and/or components of the data processing device or actuate varieties of functionalities provided by the specific modules and/or components.

However, the setting mode provided by the prior art BIOS displays few setting options of parameters or switches of basic functions. For example, the setting mode provided by the prior art displays a system date and time setting, a power-on disk slot selection, a build-in sound card and/or display card switch, an IDE bus master/slave setting, etc. As for the parameters or on/off switches of complex or less used functions, such as a configuration of bit-stream speed of a universal serial bus (USB), will are generally preset by the system manufacturer as a hidden state, in order to prevent any user from changing the setting of parameters or on/off switches in an involuntary situation that would further cause the data processing device to operate abnormally.

The above-mentioned hidden state can prevent user from erroneous setting, but some BIOS setting errors already exist before the data processing device leaves its manufacturer, for a professional user, these errors might be solved by means of resetting. Because that the user can not display the hidden debugging mechanism, besides sending the data processing device back to the manufacturer for resetting, there is no chance to amend the mistake directly, thereby decreasing the debugging efficiency. Only if the setting of the previously mentioned complex or less used functional parameters or on/off switches directly opens to the user to save the aftermath problem that is caused by the erroneous setting and also concerned by the manufacturer.

In summary, it is a highly urgent issue in the industry for how to provide a technique which can effectively prevent the user from wrongfully setting complex or less used functional parameters or on/off switches, and further based on the demand, open the complex and less used functional parameters or on/off switches to user for resetting in order to solve the drawbacks of the prior art as mentioned above.

### SUMMARY OF THE INVENTION

In views of the disadvantages of the prior art mentioned above, the present invention provides a basic input/output system (BIOS) debugging system and method, which effectively prevents the user from wrongfully setting complex or less used functional parameter or on/off switches, and further opens the complex and less used functional parameters or on/off switches to user for resetting based on the demand.

The BIOS debugging system according to the present invention is applicable to a BIOS that has a debugging mechanism hidden by the BIOS in normal operation. The BIOS debugging system includes a determination module, which is used for determining, at the time when the BIOS executes a power on self test (POST), whether at least a preset input mode that is for a user to enter the hidden debugging mechanism is actuated or not, and entering the setting mode of the EIOS and displaying the hidden debugging mechanism if the preset input mode is actuated, or continuing executing the POST; an actuation module, which is used for the user to enter the setting mode of the BIOS and display the hidden debugging mechanism when the determination module determines that the preset input mode is actuated; and a setting module, which is used for executing the debugging functions provided by the debugging mechanism and/or resetting the parameters provided by the debugging mechanism.

According to the preferred embodiment of the present invention, the input mode indicates that a specific key is pressed, and the determination module, after determining that the input mode is actuated, further requests the user to input identification information that are used to identify whether the user has an authority to display the hidden debugging mechanism and whether the input identification information are correct or not based on the preset identification information, and enters the BIOS setting mode and displays the hidden debugging mechanism if the identification information are correct, or continues executing the POST.

The BIOS debugging method of the present invention is implemented according to the BIOS debugging system of the present invention. The BIOS debugging method includes the following steps: (1) in a POST executed by the BIOS, determining whether at least a preset input mode that is used for a user to enter the debugging mechanism is actuated or not, and proceeding to step (2) if the input mode is actuated, or continuing executing the POST; (2) entering the setting mode of the BIOS and displaying the hidden debugging mechanism; and (3) executing debugging functions provided by the debugging mechanism and/or resetting parameters provided by the debugging mechanism.

According to the preferred embodiment of the present invention, the input mode indicates that at least a specific key is pressed, and step (1), after determining that the input mode is actuated, further requests that the user to input identification information that are used to identify whether the user has an authority to display the hidden debugging mechanism and whether the input identification information are correct or not based on the preset identification information, and proceeds to step (2) if the identification information are correct, or continues executing the POST.

Compared with the prior art, the BIOS debugging system and method according to the present invention, through the interoperation of the above-mentioned determination module, actuation module, and setting module, in a better embodiment further including a storage module, can not only prevent the user from wrongfully setting the complex or less used functional parameters or on/off switches, but also further open the complex or less used functional parameters or on/off switches to the user for setting based on the demand, thereby enhancing the debugging efficiency of the basic input/output system.

### BRIEF DESCRIPTION OF DRAWINGS

The present invention can be more fully understood by reading the following detailed description of the preferred embodiments, with reference made to the accompanying drawings, wherein:

FIG. 1 is a functional block diagram of a data processing device having a basic input/output system (BIOS) and a BIOS debugging system of the preferred embodiment according to the present invention; and

FIG. 2 is a flow chart of a BIOS debugging method corresponding to the BIOS debugging system shown in FIG. 1.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

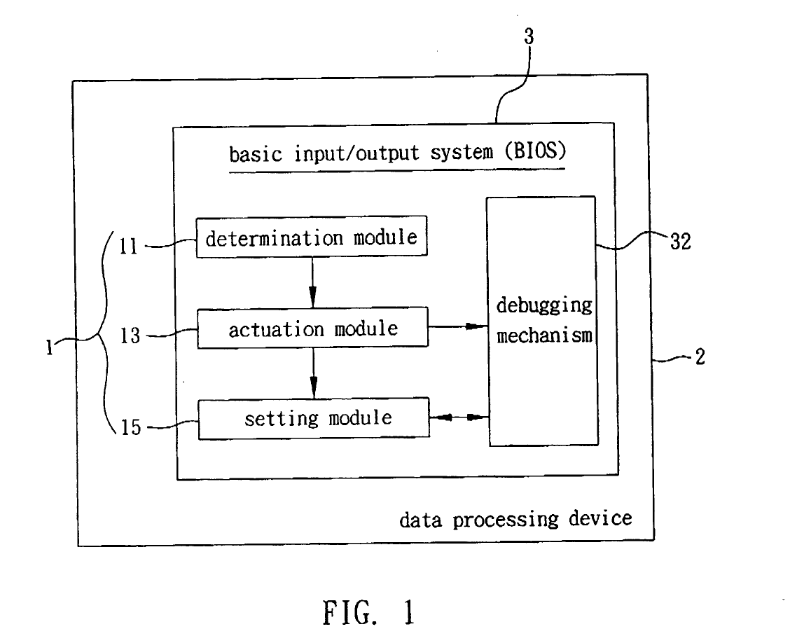

Please refer to FIG. 1, which is a functional block diagram of a data processing device 2 having a basic input/output system (BIOS) 3 and a BIOS debugging system 1 of the preferred embodiment according to the present invention. The BIOS debugging system 1 is applied to the BIOS 3 of the data processing device 2. The data processing device 2 is, for example but not limited to, a palm pilot, a notebook computer, a laptop computer, a personal computer, a server, and a workstation, all of which have a data processing function. The BIOS 3 has a debugging mechanism 32, and the debugging mechanism 32 is hidden by the BIOS 3 in a normal operation. More specifically, when the BIOS 3 executes a power on self test (POST) and a user enters the setting mode of the BIOS 3, a display unit (not shown) of the data processing device 2 will not display the debugging mechanism 32. In other words, the user is unable to set the hidden debugging mechanism 32.

The BIOS debugging system 1 of the present invention comprises a determination module 11, an actuation module 13, and a setting module 15.

The determination module 11, at the time when the BIOS 3 executes the POST, determines whether a preset input mode, which is used for the user to enter the hidden debugging mechanism 32, is actuated or not, and allows the user to enter the setting mode of the BIOS 3 and displays the debugging mechanism 32 on the display unit if determining that the preset input mode is actuated, or continues executing the POST.

According to the preferred embodiment, the preset input mode indicates a state when at least a specific key of the data processing device 2 is pressed. For example, the input mode indicates a state when four keys-“Ctrl”, “Shift”, “Alt” and “A”-are pressed simultaneously. Accordingly, when the BIOS 3 executes the POST, the determination module 11 determines whether all of the four keys are pressed simultaneously. Such a determination mechanism can be realized by a keyboard controller provided by the prior art BIOS.

Preferably, the determination module 11, after determining that the input mode is actuated, further requests the user to input identification information that are used for identifying whether the user has an authority to actuate the display unit of the data processing device 2 to display the hidden debugging mechanism 32, and determines whether the input identification information is correct or not based on preset identification information. If the input identification information is correct, the user is allowed to enter the setting mode of the BIOS 3 and the hidden debugging mechanism 32 is displayed on the display unit of the data processing device 2, or the BIOS 3 continues executing the POST. Such an identification information determining mechanism can further ensure that the user, who is authorized to enter the debugging mechanism 32, is indeed a user who is already authorized by the BIOS 3. According to the preferred embodiment, the identification information are, but not limited to, an account number or a password.

The actuation module 13, after the determination module 11 has determined that the preset input mode is actuated, allows the user to enter the setting mode of the BIOS 3 and actuates the display unit of the data processing device 2 to display the hidden debugging mechanism 32. In addition to the system date and time setting, the power-on disk slot selection, the build-in sound card and/or display card switch, and IDE bus master/slave setting, which the setting mode of the prior art BIOS already have, the setting mode of the BIOS 3 further includes the complicated or less used functions such as the configuration of bit-stream speed of the USB.

The setting module 15 executes debugging functions provided by the debugging mechanism 32 and/or resets parameters provided by the debugging mechanism 32. According to the preferred embodiment, after the actuation module 13 enters the setting mode of the BIOS 3 and actuates the display unit to display the debugging mechanism 32, the setting module 15 executes the debugging functions provided by the debugging mechanism 32 and/or resets the parameters provided by the debugging mechanism 32 based on operation commands, digits and/or signs input by the user. For example, problems resulting from erroneous setting of the configuration of the bit-stream speed of the USB can be avoided through a resetting of the configuration of the bit-stream speed of the USB. It should be noted that, the debugging mechanism 32 provides more debugging functions and/or more functional parameter options provided by the debugging mechanism 32 for resetting.

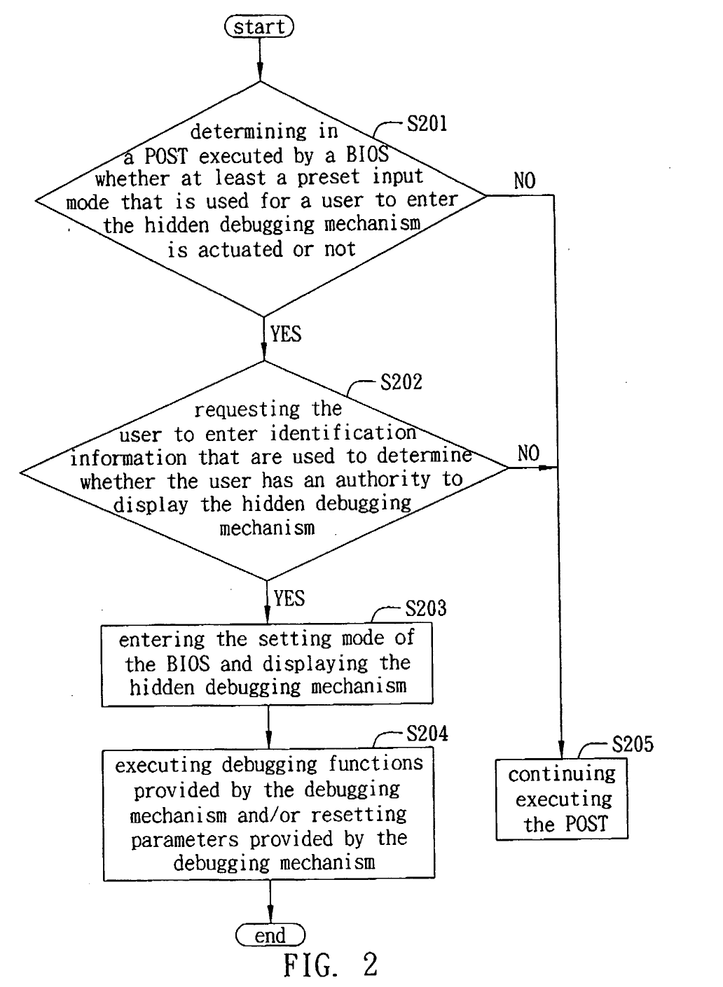

Please refer to FIG. 2, which is a flow chart of BIOS debugging method corresponding to the BIOS debugging system 1. The method starts in step S201. In step S201, when the BIOS 3 executes the POST, whether a preset input mode for entering the hidden debugging mechanism 32 is actuated or not is determined. If the preset input mode is determined to be actuated, the method proceeds to step S202, or the method proceeds to step S205.

In step S202, the user is requested to input the identification information. If the input identification information is correct, the method proceeds to step S203, or the method proceeds to step S205.

In step S203, the user is allowed to enter the setting mode of the BIOS 3 and the hidden debugging mechanism 32 is displayed on the display unit of the data processing device 2. The method proceeds to step S204.

In step S204, the debugging functions provided by the debugging mechanism 32 and/or reset the parameters provided by the debugging mechanism 32 are executed. According to the preferred embodiment, it is based on the operational commands, digits and/or signs input by the user to execute the debugging functions provided by the debugging mechanism and/or reset the parameters provided by the debugging mechanism.

In step S205, the BIOS 3 continues executing the POST.

In summary, the basic input/output system debugging system and method according to the present invention, through the interoperation between the determination module, the actuation module, and the setting module, and in a better embodiment also including a storage module, can not only prevent the user from wrongfully setting the complex or less used functional parameters or on/off switches, but also further open the complex or less used functional parameters or on/off switches to the user for resetting, thereby, increasing the debugging efficiency.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A basic input/output system (BIOS) debugging system, which is applicable to a BIOS that has a debugging mechanism hidden by the BIOS in normal operation, the BIOS debugging system comprising:
a determination module, which is used for determining, at the time when the BIOS executes a power on self test (POST), whether at least a preset input mode that is used for a user to enter the hidden debugging mechanism is actuated or not, and entering the setting mode of the BIOS and displaying the hidden debugging mechanism if the preset input mode is actuated, or continuing executing the POST;
an actuation module, which is used for the user to enter the setting mode of the BIOS and display the hidden debugging mechanism when the determination module determines that the preset input mode is actuated; and
a setting module, which is used for executing debugging functions provided by the debugging mechanism and/or resetting parameters provided by the debugging mechanism.

2. The BIOS debugging system of claim 1, wherein the input mode indicates that a specific key is pressed.

3. The BIOS debugging system of claim 1, wherein the determination module, after determining that the input mode is actuated, further requests the user to input identification information that are used to determine whether the user has an authority to display the hidden debugging mechanism, determines whether the identification information input by the user are correct or not based on the preset identification information, and enters the setting module of the BIOS and displays the hidden debugging mechanism if the identification information are correct, or continues executing the POST.

4. A BIOS debugging method, which is applicable to a BIOS that has a debugging mechanism bidden by the BIOS in normal operation, the BIOS debugging method comprising the following steps of:
(1) determining in a POST executed by the BIOS whether at least a preset input mode that is used for a user to enter the debugging mechanism is actuated or not, and proceeding to step (2) if the input mode is actuated, or continuing executing the POST;
(2) entering the setting mode of the BIOS and displaying the hidden debugging mechanism; and
(3) executing debugging functions provided by the debugging mechanism and/or resetting parameters provided by the debugging mechanism.

5. The BIOS debugging method of claim 4, wherein the input mode indicates that a specific key is pressed.

6. The BIOS debugging method of claim 4, wherein step (1), after determining that the input mode is actuated, further requests the user to input identification information that are used to determine whether the user has an authority to display the hidden debugging mechanism, determines whether the identification information input by the user are correct or not based on the preset identification information, and proceeds to step (2) if the identification information are correct, or continues executing the POST.
